(19) United States
(12) Patent Application Publication
(10) Pub. No.: US 2025/0322635 A1
(43) Pub. Date: Oct. 16, 2025

(54) METHOD FOR TEMPORAL SYNCHRONIZATION OF DATA DETECTION WITH A TEST VEHICLE AND A DRONE

(71) Applicant: Robert Bosch GmbH, Stuttgart (DE)

(72) Inventors: Csaba Marosi, Budapest (HU); Gergely Treplan, Budapest (HU); Imre Benedek Juhasz, Budapest (HU); Mate Fugerth, Budapest (HU)

(21) Appl. No.: 19/096,023

(22) Filed: Mar. 31, 2025

(30) Foreign Application Priority Data
Apr. 11, 2024 (DE) 10 2024 203 336.7

(51) Int. Cl. G06V 10/145; G01M 17/007; G06V 10/80; G06V 20/17

(52) U.S. Cl. CPC G06V 10/145; G01M 17/007; G06V 10/803; G06V 20/17; G06V 2201/08

(57) ABSTRACT

A method for temporal synchronization of data detection using a test vehicle and data detection using a drone which accompanies the test vehicle. The method includes the following steps: a) recognizing signals and/or features of the operation of the test vehicle in video data recorded using a camera of the accompanying drone; b) performing the temporal synchronization using the signals and/or features recognized in step a).

### CROSS REFERENCE

The present application claims the benefit under 35 U.S.C. § 119 of German Patent Application No. DE 10 2024 203 336.7 filed on Apr. 11, 2024, which is expressly incorporated herein by reference in its entirety.

### FIELD

The development of systems for highly automated and autonomous driving of motor vehicles is fundamentally challenging.

Such systems typically comprise neural networks with which sensor data obtained from the environmental sensors of the motor vehicle are analyzed and evaluated.

The development of such systems therefore requires, in particular, a very large amount of training data that can be used for training neural networks. Such data are also designated as “labeled data.” This means that certain information is known for the data, which a neural network is supposed to independently recognize from comparable data. Such data are needed for training neural networks, because such data can be used to introduce information into neural networks. Regular so-called “ground truth” data are required to train neural networks for evaluating sensor data of a vehicle. Such data show where certain objects in the environment of the vehicle, which can be recognized by the sensors of the vehicle, are actually positioned in a ground-referenced coordinate system describing the environment of the motor vehicle. Sensors in the motor vehicle can only recognize objects from the particular viewing perspective of the sensor from the motor vehicle. With the aid of “ground truth” data related to such objects, neural networks can be trained to evaluate sensor data from such sensors in order to reliably recognize the position of objects in the ground-referenced coordinate system for describing the environment of the motor vehicle.

Obtaining such “ground truth” data is complex. A conventional approach is to obtain such data with the aid of a drone which accompanies a vehicle that is carrying out test drives to obtain data for training neural networks. Such a drone preferably hovers above the test vehicle during the test drive. Preferably, such a drone is equipped with a camera that recognizes the test vehicle and its environment along with the objects in this environment. Due to the top-down perspective with which such a camera views the vehicle and the objects, ground truth data can be recognized much more easily and accurately with such a drone and its camera, using less complex evaluation systems than are required for the evaluation of data from sensors on the motor vehicle. By positioning a drone at an adjustable distance above the vehicle, obtaining training data in this way is highly advantageous—in particular if the training data to be obtained comprise the described “ground truth” data.

When using drones to obtain training data, it is often necessary to be able to determine the relative position between the drone and the test vehicle very precisely. This is particularly necessary in order to be able to correctly align the camera image of the drone in a coordinate system of the test vehicle.

In particular, an (unrecognized) rotational shift of the drone relative to the motor vehicle is regularly problematic for the use of camera images recorded using the drone to obtain training data. For example, an angular error of 0.1 degree leads to relative (false) displacements of up to 10 cm of objects that are 50 meters away from the test vehicle. However, the recognition of positions of objects in the surrounding area of a vehicle having on-board sensors in the centimeter range is a goal that should be achieved by appropriate training of neural networks for evaluating sensor data from such sensors. Thus, training data must achieve comparable or even higher accuracy.

In order to create high-precision reference data with the aid of video data recorded using the camera of a drone flying above a test vehicle, precise spatial and temporal synchronization of the coordinate systems of the drone and the test vehicle is necessary. Due to the data processing in the test vehicle and the data processing in the drone, time delays or shifts can occur, which make it difficult to link data created by cameras on the drone and data obtained by environmental sensors on the motor vehicle.

For spatial synchronization of the coordinate systems of the test vehicle and the drone, conventional approaches include provision of markers on the test vehicle (in particular on its roof) that can be recognized in camera images/camera data recorded with a camera on the drone. Using such markers, the spatial alignment and position of the test vehicle can be recognized in the camera images/camera data.

In particular, temporal synchronization means that it is possible to temporally assign camera images recorded using the camera on the drone with data recorded using sensors on the test vehicle.

Time synchronization between the test vehicle and the drone should meet the following requirements:
High precision: This means that the temporal assignment should be as accurate as possible;
Low costs: This means, in particular, that the necessary hardware in the test vehicle and drone for the temporal assignment should be as cost-effective as possible;
If possible, no or as little additional measuring equipment in the drone; and
If possible, no or as little additional measuring equipment as possible in the test vehicle;
If possible, no influence of environmental conditions and/or geographical circumstances on the possibility and accuracy of time synchronization.

A basic possibility for temporal synchronization would be a lidar system. Objects that are visible both to the sensors of the test vehicle and in the video data recorded by the camera of the drone could initially be used for spatial synchronization. Once spatial synchronization is complete, temporal synchronization can also be carried out using the location of the object from the drone's perspective and from the perspective of the test vehicle at a given point in time.

It has also been suggested to perform time synchronization by means of GNSS time signals received by both the drone and the test vehicle.

Markers on test vehicles, which are recognized in the video data created by cameras on the drone, were proposed for the spatial synchronization of the measurement systems on the test vehicle and the drone.

What these methods have in common is that, in addition to the sensor data obtained in the motor vehicle and the camera data obtained using the camera of the drone, further data must be recorded that make temporal assignment of certain sensor data to certain camera data possible.

### SUMMARY

It is the object of the present invention to at least partially solve the problems described with reference to the related art. This object may be achieved by certain features of the present invention. Advantageous example embodiments of the present invention are disclosed herein. It should be noted that in view of the present invention, a person skilled in the art combines the individual features in a technologically meaningful manner and thus arrives at further embodiments of the present invention.

The present invention includes a method for temporal synchronization of data detection using a test vehicle and data detection using a drone which accompanies the test vehicle. According to an example embodiment of the method invention, the method comprises the following steps:
a) recognizing signals and/or features of the operation of the test vehicle in video data recorded using a camera of the accompanying drone;
b) performing the temporal synchronization using the signals and/or features recognized in step a).

According to an example embodiment of the present invention, it is particularly preferred if the following step is performed before step b):
a′) ascertaining operating parameters of the operation of the test vehicle that allow a comparison with the features of the operation of the test vehicle recognized in step a),
   wherein, in step b), the operating parameters ascertained in step a′) are additionally used to perform the temporal synchronization.

Spatial synchronization by means of markers on the test vehicle, which are recognized in the video data created using the drone, is one approach for spatial synchronization, because the spatial assignment/linking of the test vehicle and the drone video data relative to one another is carried out directly. There is no use of a third coordinate system in which both the spatial positioning/orientation of the test vehicle and the spatial positioning/orientation of the drone are classified. Rather, the spatial linking/synchronization is carried out directly from the video data of the drone to the test vehicle.

The approach described here for the temporal synchronization of the drone and the test vehicle according to an example embodiment of the present invention takes the properties of the spatial synchronization of drone and test vehicle and transfers these properties to the temporal synchronization. Furthermore, the approach described here makes it possible to at least partially dispense with additional hardware on the drone and/or test vehicle to perform the temporal synchronization.

The approach according to an example embodiment of the present invention to temporal synchronization can be implemented in various ways. What all approaches have in common is that signals and/or features of the operation of the test vehicle are recognized in the video data and evaluated for temporal synchronization in step b). The data used for synchronization are present in the video data. No additional synchronization data needs to be recorded in addition to the video data. Such synchronization data would have to be recorded and stored in the test vehicle and the drone, in each case in addition to the video data or the operating data, in order to be able to perform temporal synchronization later. This step can be omitted using the approach described here. Such additional synchronization data would be, for example, GNSS timestamps, which are assigned in each case to the data obtained on the test vehicle and the data obtained in the drone, and using which certain data can be assigned to a certain GNSS timestamp in order to then be assignable to one another via the GNSS timestamp.

In principle, the described method of the present invention becomes simpler and more accurate if features and/or signals of the operation of the test vehicle in the video data are used for temporal synchronization, because intermediate steps can be omitted.

According to an example embodiment of the present invention, it is also advantageous if, in step a), operating parameters of the operation of the drone are recorded, which are used to perform the temporal synchronization in step b).

The method described here according to the present invention can also be performed in a subsequent method step after ascertaining data using the video data and the operating data recorded by the vehicle during operation of the test vehicle. Video data from the camera of the drone and operational data from the operation of the test vehicle can be recorded and stored independently. Subsequently, in a processing step b), temporal synchronization can be carried out using the described method.

Furthermore, according to an example embodiment of the present invention, it is preferred if, in step a), features of a movement of the test vehicle are recognized and, in step a′), data from an inertial sensor system of the test vehicle are ascertained as operating parameters.

According to an example embodiment of the present invention, movements of the test vehicle can be recognized both using the operating parameters of the test vehicle and using video data recorded by the camera of the drone. Movements of the test vehicle can be seen in the drone's video data. Movements of the test vehicle are, in particular, features of the operation of the test vehicle that occur during operation of the test vehicle. It is not necessary to record additional data if these features of the operation of the test vehicle are used for temporal synchronization.

According to an example embodiment of the present invention, it is further advantageous if, in step a), speeds and/or yaw rates of the test vehicle relative to the ground are recognized as signals and/or features, and, in step a′), corresponding speeds and/or yaw rates of the test vehicle are ascertained as operating parameters.

Furthermore, according to an example embodiment of the present invention, it is preferred if steps a) and a′) are carried out in parallel for a minimum time interval so that, after performing steps a) and a′), in each case a temporal profile of signals and/or features and operating parameters of the operation of the test vehicle is available, wherein performing the synchronization in step b) comprises the comparison of a temporal profile of signals and/or features ascertained in step a) and a temporal profile of operating parameters ascertained in step a′). According to an example embodiment of the present invention, it is also advantageous if step b) comprises solving an optimization function in which a time shift parameter is minimized.

In each case, the described movements of the test vehicle (yaw rate and/or speeds) are preferably described in relation to the ground. This is preferably done on the basis of both the operating parameters of the test vehicle and the video data obtained using the camera of the drone. Preferably, the description in relation to the ground in each case is carried out independently of one another. Based on the video data, the movements of the test vehicle must be recognized in the camera image. Based on the operating parameters, the movements of the test vehicle may need to be ascertained from data from an inertial sensor system and then described in relation to the ground with the aid of these data. The speeds/yaw rates determined based on the operating parameters of the test vehicle are designated here as V_{Test vehicle}. The speeds/yaw rates determined on the basis of the drone's video data are designated here as V_{Test vehicle,DRONE}.

The speed of the test vehicle V_{Test vehicle,DRONE} can be calculated, for example, by the sum of the speed of the drone along with the relative speed between the drone and the test vehicle:

$${V}_{Test vehicle , DRONE} = {V}_{DRONE , Ground} + {V}_{Relative , Test vehicle , DRONE}$$

Both V_{DRONE,Ground} as well as V_{relative,Test vehicle,DRONE} can be ascertained from the video data recorded by the drone.

The temporal synchronization can then be found very precisely using the speeds V_{Test vehicle} and V_{Test vehicle,DRONE} with an optimization function that ascertains, for example, a minimum deviation between the two speeds V_{Test vehicle} and V_{Test vehicle,DRONE} over a time interval. Such an optimization function can be structured as follows:

$$Δ {t}_{opt} {=}_{Δ t}^{argmin} ‖ {V}_{Test vehicle} ( t ) - {V}_{Test vehicle , DRONE} ( t + Δ t ) ‖$$

∥ . . . ∥ denotes a normalization (for example, according to the L1 norm or the L2 norm, etc.), which is used to normalize the difference between the two speed signals.

A main advantage of this method of the present invention is that it can be performed purely on a software basis. Only the spatial synchronization marker on the roof of the vehicle is required in order to perform this temporal synchronization method. Using these markers, V_{Relative,test vehicle,DRONE} is determined from the video data the drone.

The speeds are considered over a time interval, so that static errors in speed determination can be at least partially cancelled out during the determination of Δtₒₚₜ.

In other approaches of the method of the present invention described here, as an alternative to speeds and/or yaw rates, a relative position and/or orientation of the test vehicle relative to other objects can also be used when performing the described method. For this purpose, objects must be used that are visible in the video data and that are recognized by the environmental sensor system of the test vehicle. Based on such objects, temporal synchronization can also be carried out using the described method. For example, distances to these objects at certain points in time can be used to perform temporal synchronization. Distances to such objects can also be observed over a time interval in order to perform temporal synchronization by solving an optimization function.

However, compared to the method of the present invention described above for using speeds and/or yaw rates, such approaches may result in slight offset errors in the position estimation, which may be present in particular due to offsets in the environmental sensor system of the motor vehicle and/or in the evaluation of the video data from the camera of the drone.

Such offsets can lead to errors/or inaccuracies in temporal synchronization. It is advantageous to directly use the speed and yaw rate of the test vehicle as a comparison value for synchronization. These parameters are readily available in both the video data and the operating parameters of the motor vehicle, with minimal offsets.

Instead of using accelerations and/or yaw rates for temporal synchronization, general data from an inertial sensor system (IMU) present in the test vehicle can also be used.

The option of performing temporal synchronization using measurements of speeds of the test vehicle with the drone and the test vehicle itself is thus further abstracted. It is possible to record kinematic parameters of the movement of the drone and the movement of the test vehicle in each case over time intervals using an inertial sensor system in the drone and in the test vehicle. Just as the speed V_{Test vehicle,DRONE} can be ascertained from the video data of the drone, an acceleration value or a vector with a plurality of acceleration values in different spatial directions Q_{Test vehicle,DRONE,IMU} can also be determined using video data of the drone. A corresponding acceleration value or vector Q_{Test vehicle,IMU} can also be determined for the test vehicle. Relative acceleration values for relative accelerations between the test vehicle and the drone can also be ascertained from the video data, so that Q_{Test vehicle,DRONE,IMU} can preferably be ascertained using the following relationship:

$${Q}_{Test vehicle , DRONE , IMU} = {Q}_{DRONE , Ground , IMU} + {Q}_{Relative , Test vehicle , DRONE} .$$

The optimization function for ascertaining the temporal synchronization is then also structured accordingly:

$$Δ {t}_{opt} {=}_{Δ t}^{argmin} ‖ {Q}_{Test vehicle , IMU} ( t ) - {Q}_{Test vehicle , DRONE , IMU} ( t + Δ t ) ‖$$

For this approach, time-synchronized inertial sensors are required in both the test vehicle and the drone. However, such an inertial sensor system is associated with moderate additional costs. Here, the actual synchronization is also carried out via Q_{Relative,Test vehicle,DRONE}. This term is determined in the video data of the drone.

According to an example embodiment of the present invention, it is also preferred if the test vehicle is configured to emit a temporal signal pattern, which is recognized in the video data in step a).

This approach according to an example embodiment of the present invention differs from the approaches described above in that, here, a signal specifically designed for temporal synchronization is emitted by the test vehicle, which is recognizable in the video data and can be used for temporal synchronization. Such a signal can in principle be used for temporal synchronization in the same way as the movements of the test vehicle. It is important that the data/information for temporal synchronization is available in the video data itself and can be used from the video data, without the need for any further information (besides the operating parameters of the motor vehicle).

The use of parameters specifically emitted by the test vehicle for temporal synchronization makes possible simpler methods of synchronization than using the movements of the test vehicle. In particular, calculation steps that take into account relative speeds between the test vehicle and the drone may be omitted.

Furthermore, according to an example embodiment of the present invention, it is preferred if the temporal signal pattern comprises at least one light signal.

A light source for emitting temporal signals is preferably installed on the test vehicle. Preferably, the light source is configured so that it emits its light signals at fixed points in time—for example, with a certain regularity. In particularly advantageous embodiments of the present invention, a sequence of light signals of different lengths and/or with different time intervals is emitted, which can be recognized as a code in the video data recorded by the camera of the drone. Using the code, a temporal assignment can be carried out, which can be used for temporal synchronization.

For carrying out this design variant of the described method of the present invention, an additional light signal source is required on the test vehicle. This is a manageable effort.

According to an example embodiment of the present invention, it is also preferred if the temporal signal pattern is generated using a regular light source present on the test vehicle.

According to this design variant of the present invention, the temporal synchronization can be carried out by light signals emitted by light sources already present in the test vehicle. For example, indicators and/or the taillight of the test vehicle can be used to emit light signals that can be recognized in video data recorded by the camera of the drone and can then be used for temporal synchronization.

If applicable, a mirror can be arranged on the test vehicle, with which the light signal from a light source such as the indicator or the rear light of a vehicle is deflected towards the drone (preferably upward and preferably only partially), in order to ensure good visibility of the light signal in the video data.

Also to be described here is a data processing device according the present invention, comprising a processor which is adapted and/or configured to carry out the described method of the present invention.

Further described is a computer program product according to the present invention, comprising commands which, when the computer program product is carried out by a computer, cause said computer to carry out the described method of the present invention.

Further described is a computer-readable storage medium of the present invention, comprising commands which, when carried out by a computer, cause said computer to carry out the described method of the present invention.

Example embodiments of the present invention and the technical environment of the present invention are explained in more detail below with reference to the figures. The figures show preferred exemplary embodiments, to which the present invention is not limited. It should be noted, in particular, that the figures and in particular the size proportions shown in the figures are only schematic.

### BRIEF DESCRIPTION OF THE DRAWINGS

FIG. 1 is a schematic representation of a drone observing a vehicle, according to an example embodiment of the present invention.

FIG. 2 shows vehicles having markings for identification in video data, according to an example embodiment of the present invention.

FIG. 3 shows a comparison of speed profiles obtained using various methods, according to an example embodiment of the present invention.

FIG. 4 shows inertial sensor system data from an inertial sensor system of the drone and from an inertial sensor system of a vehicle in a global coordinate system, according to an example embodiment of the present invention.

FIG. 5 is a first design variant of temporal synchronization of a vehicle and a drone with light signals, according to an example embodiment of the present invention.

FIG. 6 shows a second first design variant of temporal synchronization of a vehicle and a drone with light signals, according to an example embodiment of the present invention.

FIG. 7 is a schematic flow diagram of the described method according to an example embodiment of the present invention.

### DETAILED DESCRIPTION OF EXAMPLE EMBODIMENTS

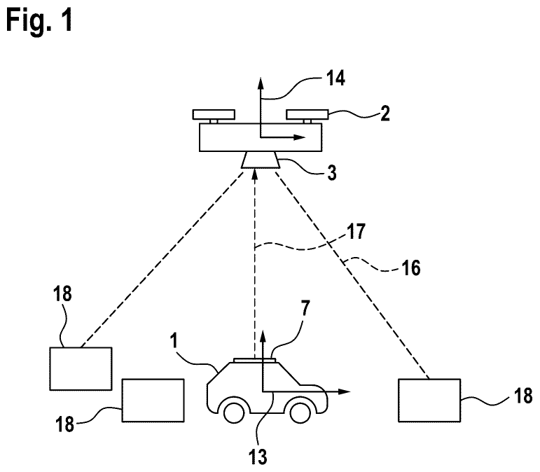

FIG. 1 shows a schematic representation of a drone 2 which accompanies a test vehicle 1 and observes from an observation position 17 above the test vehicle 1. The drone 2 has a camera 3 which has a downward-facing field of view 16 and by means of which camera data or video data can be generated in which the test vehicle 1 and other objects 18 in the surrounding area of the test vehicle 1 are recognizable/visible. Camera data or video data obtained using the camera 3 on the drone 2 are available in a drone coordinate system 14, which is indicated schematically here. The camera data or video data can be used to build a reference model with which sensors on the test vehicle 1 can be calibrated or algorithms for evaluating the data from such sensors can be improved. Such sensors can in particular be environmental sensors with which the environment of the test vehicle 1 can be monitored and with which objects 18 in the surrounding area of the test vehicle 1 can be recognized and tracked. Data obtained using environmental sensors 1 on the test vehicle 1 are available in a vehicle coordinate system 13. In order to use the camera data from the camera 3, a conversion from the vehicle coordinate system 13 to the drone coordinate system 14 and/or vice versa is required. In order to make this conversion possible, the alignment and position of the vehicle coordinate system 13 and the drone coordinate system 14 relative to one another is required. Such calibration is possible using a marking 7 on the test vehicle 1, which can be seen in the camera data or video data of the camera 3. However, such a marking 7 primarily makes spatial synchronization of the vehicle coordinate system 13 and the drone coordinate system 14 relative to one another possible. In order to be able to compare the data from the camera 3 with the data from sensors on the test vehicle 1, temporal synchronization of the camera data or video data from the camera 3 of the drone 2 and the data from sensors on the test vehicle 1 is also necessary. A novel, particularly efficient approach is proposed here for this temporal synchronization.

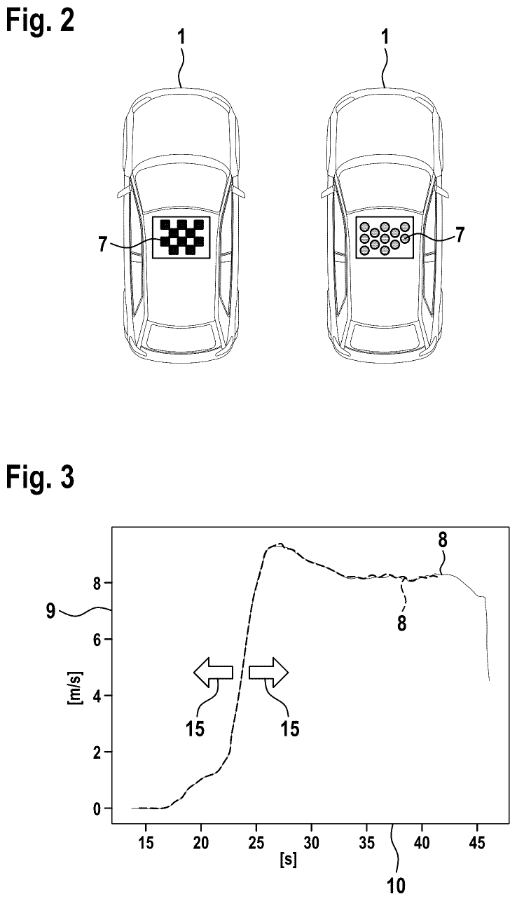

FIG. 2 shows, by way of example, various types of markings 7 on the roof of a test vehicle 1, which can be recognized in video data or camera data recorded using a drone flying above the test vehicle 1. Using these markings 7, spatial synchronization or recognition of the alignment and position of the vehicle coordinate system 13 in the drone coordinate system 14 is possible by recognizing the alignment of the marking 7 in the video data or camera data.

FIG. 3 shows speed profiles 8 that describe the speed of the test vehicle, wherein one speed profile 8 compares the speed of the test vehicle obtained using various methods. The speed profiles 8 are in each case plotted on the speed axis 9 over the time axis 10. Indicated by arrows is the temporal shift 15, which can be determined by Δtₒₚₜ using the described method or by comparing the speed profiles 8 and which corresponds to the temporal synchronization. Further above in the general part of the description, it was explained how the speed of the motor vehicle can be determined once using data available in the test vehicle as V_{Test vehicle} and once using data obtained from the drone as V_{Test vehicle,DRONE}. These two speeds do not correspond exactly due to errors in the respective measuring chains used to determine speeds. However, over a time interval, such errors at least partially cancel one another out. With the aid of the described method, a shift between the two vehicle speed profiles 8, V_{Test vehicle} and V_{Test vehicle,DRONE}, is determined, which is minimized. The temporal shift Δt forms a time parameter for the temporal synchronization of data detection in the test vehicle with data detection in the drone which accompanies the test vehicle.

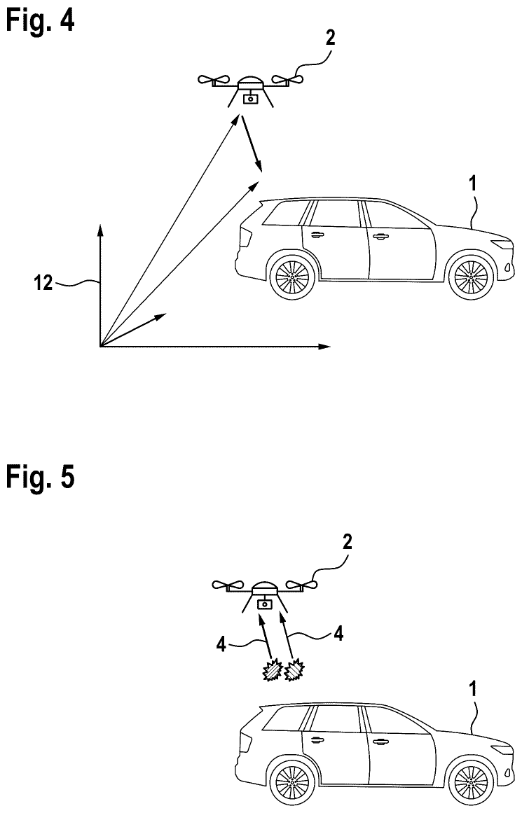

FIG. 4 graphically explains the ascertainment of speeds of the test vehicle in the data of the drone V_{Test vehicle,DRONE}. The principle described here can generally be applied to any data from an inertial sensor system (IMU), so that the speed profile is only an example. Acceleration profiles of the test vehicle can also be compared with one another, wherein the acceleration profiles are obtained once directly using an inertial sensor system in the test vehicle and once indirectly via the inertial sensor system in the drone.

It is important that the speed of the test vehicle can be ascertained on the basis of speed and acceleration data obtained from the drone.

The ground speed of the drone is determined with the aid of an inertial sensor system IMU of the drone and, if applicable, other data available in the drone. V_{DRONE,Ground}. A relative speed between the drone 2 and the test vehicle 1 V_{Relative,Test vehicle,DRONE} is possible with the aid of the marking on the test vehicle 1 described above and the video data obtained using the drone. The speed of the test vehicle 1 from the perspective of the drone 2 or based on data obtained using the drone can then be determined according to the equation described above

$${V}_{Test vehicle , DRONE} = {V}_{DRONE , Ground} + {V}_{Relative , Test vehicle , DRONE} .$$

FIG. 5 shows a first design variant of temporal synchronization of the vehicle 1 and the drone 2 using light signals; light signals 4 can be emitted by a specially provided light source on the test vehicle 1. These light signals 4 can be recognized in the video data obtained using the drone 2. Using this information in the video data, temporal synchronization is possible.

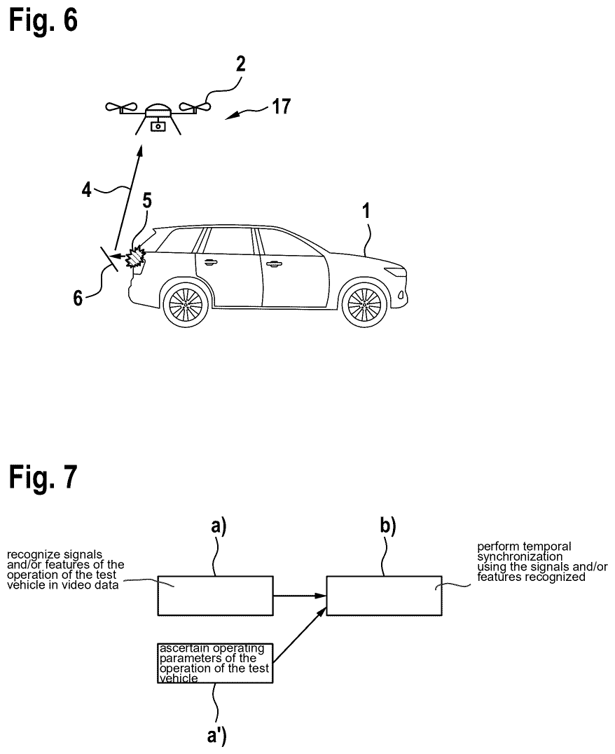

FIG. 6 shows a further developed variant of the design variant shown in FIG. 5 of temporal synchronization of a vehicle 1 and a drone 2 having light signals 4. Light signals 4 are emitted here by a light source 5 that is regularly available on the test vehicle 1, which can be, for example, an indicator of the test vehicle 1, which can be used here to generate light signals 4. In preferred design variants, a deflection device (for example, a mirror 6) can be provided on the test vehicle 1 as additional equipment, with which the light signals 4 can be redirected in the direction of the drone 2 in its observation position 17.

FIG. 7 shows a schematic flow diagram of the described method. It can be seen that method step a) and, if applicable, method step a′ are performed to obtain data that are then used to perform the temporal synchronization in step b).

What is claimed is:

1. A method for temporal synchronization of data detection using a test vehicle and data detection using a drone which accompanies the test vehicle, comprising the following steps:
a) recognizing signals and/or features of operation of the test vehicle in video data recorded using a camera of the accompanying drone; and
b) performing the temporal synchronization using the signals and/or features recognized in step a).

2. The method according to claim 1, wherein the following step is performed before step b):
a′) ascertaining operating parameters of the operation of the test vehicle that allow a comparison with the features of the operation of the test vehicle recognized in step a);
wherein, in b), the operating parameters ascertained in step a′) are additionally used to perform the temporal synchronization.

3. The method according to claim 2, wherein, in step a), the operating parameters of the operation of the drone are recorded, which are used to perform the temporal synchronization in step b).

4. The method according to claim 2, wherein, in step a), features of a movement of the test vehicle are recognized, and wherein, in step a′), data from an inertial sensor system of the test vehicle are ascertained as the operating parameters.

5. The method according to claim 4, wherein, in step a), speeds and/or yaw rates of the test vehicle relative to ground are recognized as the signals and/or features, and wherein, in step a′), corresponding speeds and/or yaw rates of the test vehicle are ascertained as the operating parameters.

6. The method according to claim 2, wherein steps a) and a′) are carried out in parallel with one another for a minimum time interval so that, after performing steps a) and a′), in each case a temporal profile of signals and/or features and the operating parameters of the operation of the test vehicle (1) is available, wherein performing the synchronization according to step b) includes the comparison of a temporal profile of the signals and/or features ascertained in step a) and a temporal profile of the operating parameters ascertained in step a′).

7. The method according to claim 1, wherein step b) includes solving an optimization function in which a time shift parameter is minimized.

8. The method according to claim 1, wherein the test vehicle is configured to emit a temporal signal pattern which is recognized in the video data in step a).

9. The method according to claim 8, wherein the temporal signal pattern includes at least one light signal.

10. The method according to claim 9, wherein the temporal signal pattern is generated using a regular light source present on the test vehicle.

11. A data processing device, comprising:
a processor adapted to temporally synchronize data detection using a test vehicle and data detection using a drone which accompanies the test vehicle, the processor adapted to:
a) recognize signals and/or features of operation of the test vehicle in video data recorded using a camera of the accompanying drone; and
b) perform the temporal synchronization using the signals and/or features recognized in step a).

12. A non-transitory computer-readable storage medium on which are stored commands for temporal synchronization of data detection using a test vehicle and data detection using a drone which accompanies the test vehicle, the commands, when executed by a computer, causing the computer to perform the following steps:
a) recognizing signals and/or features of operation of the test vehicle in video data recorded using a camera of the accompanying drone; and
b) performing the temporal synchronization using the signals and/or features recognized in step a).
